(19) United States
(12) Patent Application Publication
(10) Pub. No.: US 2024/0298130 A1
(43) Pub. Date: Sep. 5, 2024

(54) SYSTEMS AND METHODS FOR GENERATING AND APPLYING AUDIO-BASED BASIS FUNCTIONS

(71) Applicant: Sony Interactive Entertainment Inc., Tokyo (JP)

(72) Inventor: Brandon Sangston, San Mateo, CA (US)

(21) Appl. No.: 18/117,362

(22) Filed: Mar. 3, 2023

(51) Int. Cl. H04S 7/00; G10L 19/008; H04S 3/00

(52) U.S. Cl. CPC H04S 7/302; G10L 19/008; H04S 3/008; H04S 2400/01; H04S 2400/11; H04S 2420/03

(57) ABSTRACT

Systems and methods for synthesizing audio-based basis functions are described. One of the methods includes accessing a first audio dataset, which is associated with a first virtual object from a plurality of virtual objects. The method further includes encoding the first audio dataset to output a first plurality of basis functions. The method includes applying a respective one of a plurality of weights to a respective one of the first plurality of basis functions to output a first plurality of weighted basis functions and applying a respective one of a plurality of time shifts to a respective one of the first plurality of weighted basis functions to provide a first plurality of time-shifted basis functions. The method includes adding two or more of the first plurality of time-shifted basis functions to generate a plurality of groups of audio data.

### FIELD

The present disclosure relates to systems and methods for generating and applying audio-based basis functions are described.

### BACKGROUND

The video gaming industry has seen a large increase in revenue over the years. Over time, more players, including children, are interested in playing the video games. A lot of these players are interested in multiplayer video games in which multiple players control different characters to achieve a common goal. A number of these video games can be accessed for free and offer in-game items to the players.

In addition to providing haptic feedback, the video games output a variety of sounds during game play to keep the players interested and engaged. For example, a sudden shocking sound is emitted during a horror video game or music is output during a dancing video game. However, over time, the players get bored of playing the same video games and or listening to the same sounds.

It is in this context that embodiments of the invention arise.

### SUMMARY

Embodiments of the present disclosure provide systems and methods for generating and applying audio-based basis functions.

Variation generation is a large resource drawn on content creators. Sometimes, audio data is generated based on parametric descriptions to produce a larger range of possible sounds, but these techniques are still quite nascent. Sound synthesis techniques are provided herein to generate the content.

In one embodiment, an audio synthesizer for content creation that is not based on simple waveforms is provided. The audio synthesizer is based on a set of basis functions desired from a reference audio data set, such as for example, audio data to output voice, audio data for outputting footsteps, audio data to output gunshots, and audio data to output creature sounds, etc.

In one embodiment, oscillators, such as sine and cosine oscillators, are not used to build up more complex sounds. For example, sound can be decomposed into sinusoidal waveforms and cosinusoidal waveforms by applying Fourier decomposition. In the embodiment, rather than decomposing the sound into sinusoidal waveforms and cosinusoidal waveforms, a set of basis functions is defined for attaining a domain of audio data. Using statistical analysis techniques and/or neural network-based architectures, such as principal component analysis (PCA) and auto encoders, the set of basis functions, such as a set of signals, are decomposed and used to build more complex sounds. For example, sound from a slingshot is decomposed into layers, such as impact audio data, reload audio data, and fail audio data, etc. to be weighted or controlled or mixed by a user. Thus, the complex sounds, such as a gunshot synthesized sound, a voice synthesized sound, and a footstep synthesized sound, are generated.

In an embodiment, a method for synthesizing audio-based basis functions is described. The method includes accessing a first audio dataset, which is associated with a first virtual object from a plurality of virtual objects. The method further includes encoding the first audio dataset to output a first plurality of basis functions. Each of the first plurality of basis functions is represented as respective one of a plurality of sets of audio data output for a respective one of a plurality of periods of time from the first virtual object. The method includes applying a respective one of a plurality of weights to a respective one of the first plurality of basis functions to output a first plurality of weighted basis functions and applying a respective one of a plurality of time shifts to a respective one of the first plurality of weighted basis functions to provide a first plurality of time-shifted basis functions. The method includes adding two or more of the first plurality of time-shifted basis functions to generate a plurality of groups of audio data.

In one embodiment, a system for generating and applying audio-based basis functions is described. The system includes a processor that accesses a first audio dataset. The first audio dataset is associated with a first virtual object from a plurality of virtual objects. The processor encodes the first audio dataset to output a first plurality of basis functions. Each of the first plurality of basis functions is represented as respective one of a plurality of sets of audio data output for a respective one of a plurality of periods of time from the first virtual object. The processor applies a respective one of a plurality of weights to a respective one of the first plurality of basis functions to output a first plurality of weighted basis functions. The processor further applies a respective one of a plurality of time shifts to a respective one of the first plurality of weighted basis functions to provide a first plurality of time-shifted basis functions. The processor adds two or more of the first plurality of time-shifted basis functions to generate a plurality of groups of audio data. The system includes a memory device coupled to the processor.

In an embodiment, a non-transitory computer-readable medium containing program instructions for generating and applying audio-based basis functions is described. Execution of the program instructions by one or more processors of a computer system causes the one or more processors to carry out multiple operations. The operations include accessing a first audio dataset, which is associated with a first virtual object from a plurality of virtual objects. The operations further include encoding the first audio dataset to output a first plurality of basis functions. Each of the first plurality of basis functions is represented as respective one of a plurality of sets of audio data output for a respective one of a plurality of periods of time from the first virtual object. The operations include applying a respective one of a plurality of weights to a respective one of the first plurality of basis functions to output a first plurality of weighted basis functions and applying a respective one of a plurality of time shifts to a respective one of the first plurality of weighted basis functions to provide a first plurality of time-shifted basis functions. The operations include adding two or more of the first plurality of time-shifted basis functions to generate a plurality of groups of audio data.

Some advantages of the herein described systems and methods for generating and applying audio-based basis functions include generating audio content based on currently-generated audio content. For example, the currently-generated audio content is processed to obtain basis functions. Weights are applied to the basis functions to determine weighted basis functions and time shifts are applied to the weighted basis functions to obtain time-shifted weighted basis functions. Two or more of the time-shifted basis functions are added together to generate the audio content.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRA WINGS

Various embodiments of the present disclosure are best understood by reference to the following description taken in conjunction with the accompanying drawings in which:

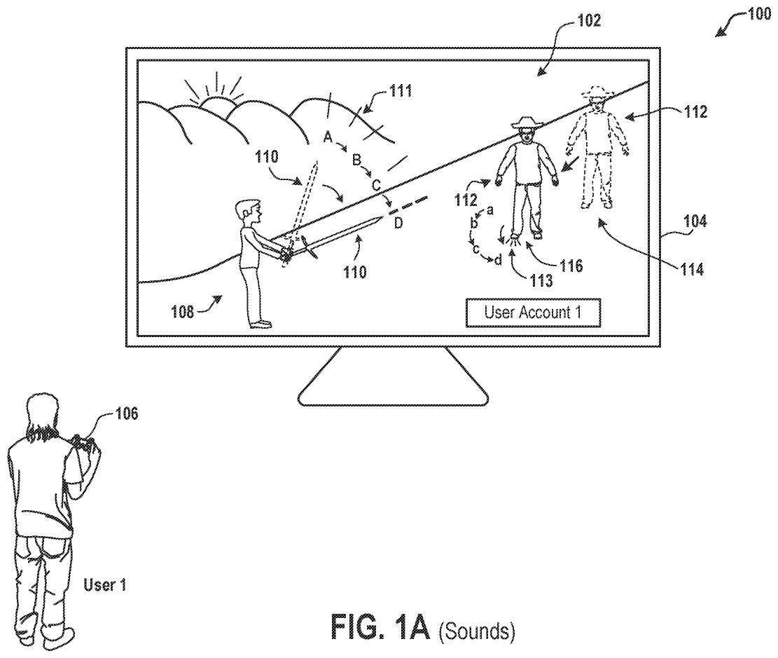

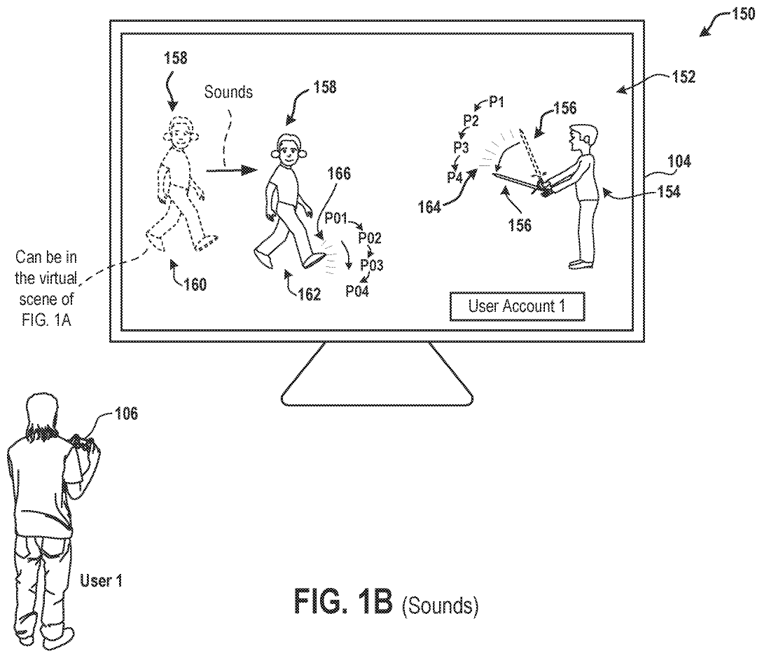

FIG. 1A is a diagram of an embodiment of a system to illustrate multiple sounds that are output simultaneously with a display of a virtual scene of a video game.

FIG. 1B is a diagram of an embodiment of a system to illustrate multiple sounds that are output simultaneously with a display of another virtual scene of a video game.

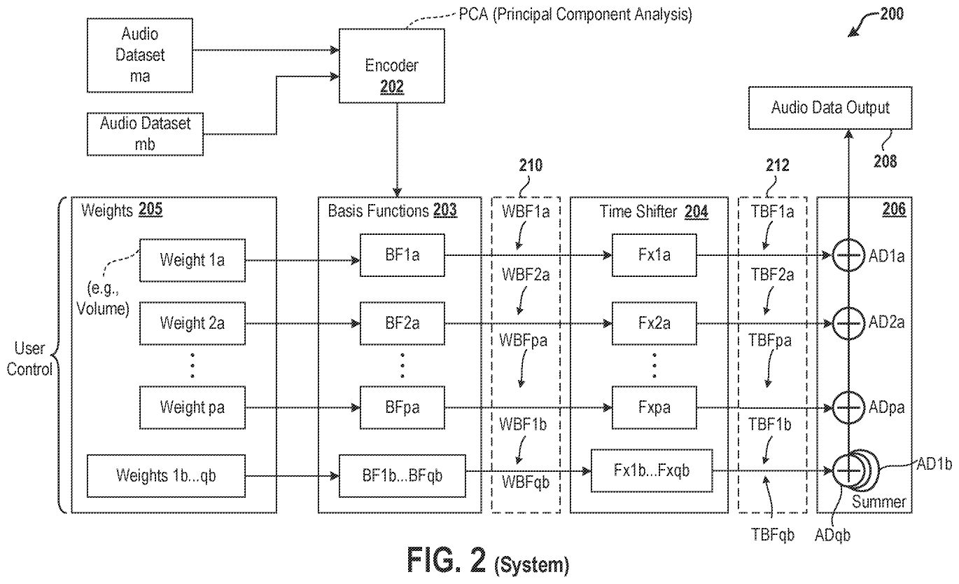

FIG. 2 is a diagram of an embodiment of a system to illustrate a method for generating and applying audio-based basis functions.

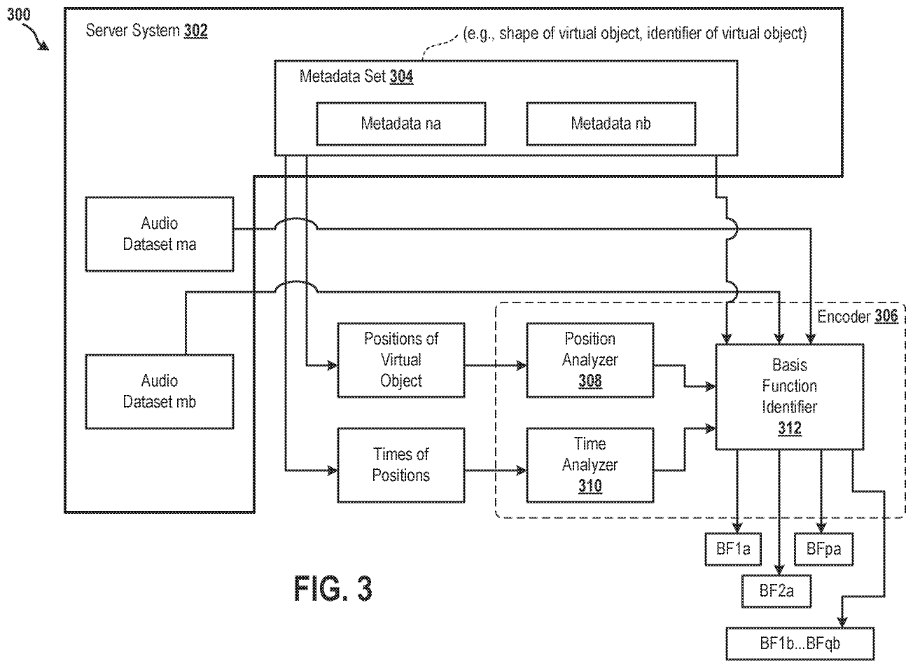

FIG. 3 is a diagram of an embodiment of a system to illustrate further details of the method of FIG. 2.

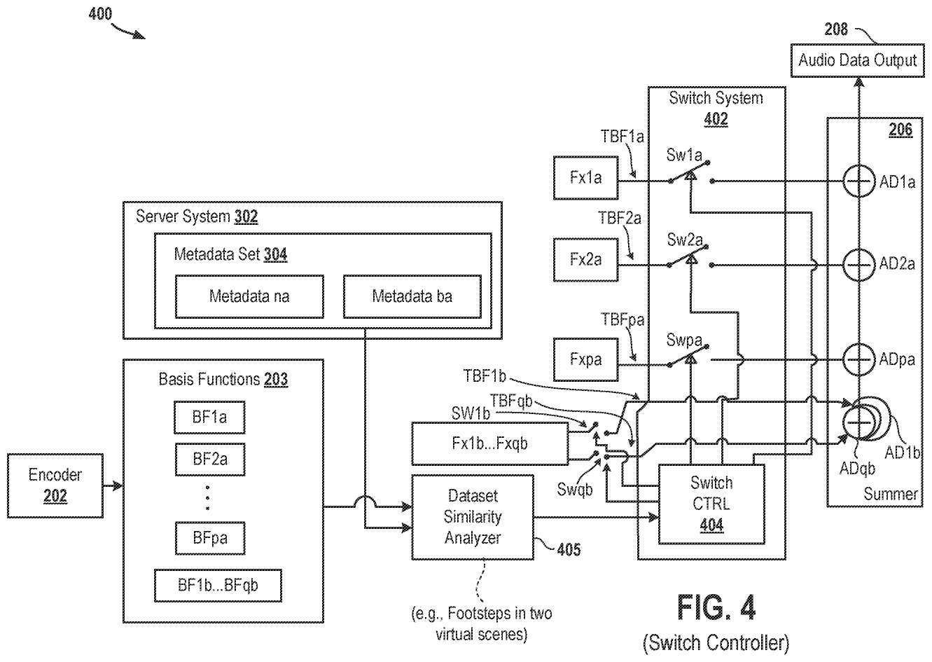

FIG. 4 is a diagram of an embodiment of a system to illustrate use of a summer with a switch system for applying the audio-based basis functions.

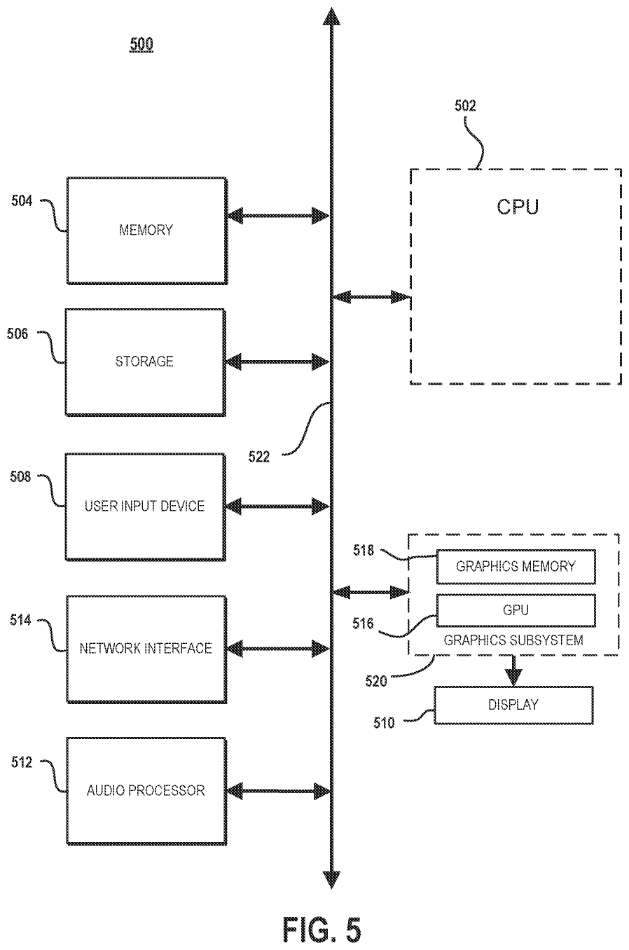

FIG. 5 illustrates components of an example device that can be used to perform aspects of the various embodiments of the present disclosure.

### DETAILED DESCRIPTION

Systems and methods for generating and applying audio-based basis functions are described. It should be noted that various embodiments of the present disclosure are practiced without some or all of these specific details. In other instances, well known process operations have not been described in detail in order not to unnecessarily obscure various embodiments of the present disclosure.

FIG. 1A is a diagram of an embodiment of a system 100 to illustrate multiple sounds that are output simultaneously with a display of a virtual scene 102 of a first video game. The system 100 includes a display device 104 and a hand-held controller 106. An example of the display device 104 includes a display device of a television, such as a smart television. As an example, instead of the display device 104, a display device of a desktop computer, a display device of a laptop computer, a display device of a smart phone, a display device of a tablet, or a display device of a head-mounted display (HMD) is used. Illustrations of a display device, as used herein, include a light emitting diode (LED) display device, a plasma display device, and a liquid crystal display (LCD) device.

Examples of the hand-held controller 106 include a Sony™ PS5™ controller. As an example, instead of the hand-held controller 106, a hand-held controller that is held in one hand of a user 1 instead of two hands, or a keyboard, or a mouse, or stylus, touch screen or another input device is used.

The user 1 uses the hand-held controller 106 to log into a user account 1 assigned to the user 1 by a server system. The server system includes one or more processors and one or more memory devices. The one or processors of the server system are coupled to the one or more memory devices of the server system. As used herein, a processor is an application specific integrated circuit (ASIC), or a programmable logic device (PLD), or a central processing unit (CPU), or a graphical processing unit (GPU), or a field programmable gate array (FPGA), or a microcontroller, or a microprocessor. One or more ASICs, one or more PLDs, one or more CPUs, one or more GPUs, one or more FPGAs, one or more microcontrollers, and one or more microprocessors are examples of hardware. Moreover, examples of a memory device include a random access memory (RAM) and a read-only memory (ROM). To illustrate, the memory device is a redundant array of independent disks (RAID) or a flash memory.

After the user 1 logs into the user account 1, the server system executes a game application, of the first video game, to generate image frames and audio frames of the virtual scene 102, and sends the image frames and the audio frames via a computer network, such as the Internet or an Intranet or a combination thereof, to a client device. Examples of the client device include a display device, described herein. To illustrate, the client device includes the display device 104 and the hand-held controller 106. As another illustration, the client device includes a game console, the hand-held controller 106, and the display device 104. As yet another illustration, the client device includes a display device and a hand-held controller.

The virtual scene 102 includes a virtual character 108 that is holding a virtual sword 110 and another virtual character 112 that is walking towards the virtual character 108. The virtual character 108, the virtual character 112, a foot, such as a right foot, of the virtual character 112, a portion, such as front, middle, or back portion, of the foot, and the virtual sword 110 are examples of virtual objects. As the virtual character 112 walks from a location 114 within the virtual scene 102 to a location 116 within the virtual scene 102, the virtual character 108 moves the virtual sword 110 from a position A to a position D via positions B and C. The position A occurs at a time tA, the position B occurs at a time tB, the position C occurs at a time tC, and the position D occurs at a time tD. Also, at the location 116, the virtual character 112 moves its right foot from a position a to a position d via positions b and c. The position a occurs at a time ta, the position b occurs at a time tb, the position c occurs at a time tc, and the position d occurs at a time td. For example, the virtual character 112 places a back portion, such as a heel portion, of its right foot first to move the right foot from the position a to the position b. Moreover, in the example, the virtual character 116 places a middle portion, such as a bridge portion, of its right foot second, and places a front portion, such as a ball portion, of its right foot third. As another example, the virtual user 116 places the front portion of its right foot first, the middle portion of its right foot second, and the back portion of its right foot third.

When the virtual sword 110 moves from the position A to the position D, one or more processors of the client device control, based on the audio frames, one or more speakers of the client device to output sounds 111 to signify the movement of the virtual sword 110. Also, during a time period in which the virtual character 112 moves its right foot from the position a to the position d, the one or more processors of the client device control, based on the audio frames, the one or more speakers of the client device to output sounds 113 to indicate the movements of the right foot.

In an embodiment, instead of the virtual character 112 moving its right foot to output the sounds 113 simultaneously with the movement of the right foot, the virtual character 112 moves its left foot to output the sounds 113 simultaneously with the movement of the left foot.

FIG. 1B is a diagram of an embodiment of a system 150 to illustrate another virtual scene 152 of a second video game. After the user 1 logs into the user account 1, the server system executes a game application, of the second video game, to generate image frames and audio frames of the virtual scene 152, and sends the image frames and the audio frames via the computer network to the client device.

The virtual scene 152 includes a virtual character 154 that is holding a virtual knife 156 and another virtual character 158 that is walking towards the virtual character 154. The virtual character 154, the virtual character 158, a left foot of the virtual character 154, a portion, such as front, middle, or back portion, of the left foot, and the virtual knife 156 are examples of virtual objects. As the virtual character 158 walks from a location 160 within the virtual scene 152 to a location 162 within the virtual scene 152, the virtual character 154 moves the virtual knife 156 from a position P1 to a position P4 via positions P2 and P3. The position P1 occurs at a time tP1, the position P2 occurs at a time tP2, the position P3 occurs at a time tP3, and the position P4 occurs at a time tP4. Also, at the location 162, the virtual character 158 moves its left foot from a position PO1 to a position PO4 via positions PO2 and PO3. For example, the virtual character 158 places a back portion, such as a heel portion, of its left foot first to move the left foot from the position PO1 to the position PO2. Moreover, in the example, the virtual character 158 places a middle portion, such as a bridge portion, of its left foot second, and places a front portion, such as a ball portion, of its left foot third. As another example, the virtual user 158 places the front portion of its left foot first, the middle portion of its left foot second, and the back portion of its left foot third. The position PO1 occurs at a time tPO1, the position PO2 occurs at a time tPO2, the position PO3 occurs at a time tPO3, and the position PO4 occurs at a time tPO4.

When the virtual knife 156 moves from the position P1 to the position P4, the one or more processors of the client device control, based on the audio frames, the one or more speakers of the client device to output sounds 164 to signify the movement of the virtual knife 156. Also, during a time period in which the virtual character 158 moves its left foot from the position PO1 to the position PO4, the one or more processors of the client device control, based on the audio frames, the one or more speakers of the client device to output sounds 166 to indicate the movements of the left foot.

In one embodiment, instead of the user 1 logging into the user account 1 to access the second video game, a second user accesses a second user account to access the virtual scene 152.

In an embodiment, instead of the virtual scene 152 of the second video game, the user 1 logs into the user account 1 to access a second virtual scene of the first video game. In the second virtual scene, image frames to display virtual characters that are same as or different from those shown in the virtual scene 102 are generated by the one or more processors of the server system. Moreover, the one or more processors of the server system generate audio frames for outputting sounds with the display of the virtual characters in the second virtual scene. For example, a first set of the sounds is output by the one or more speakers of the client device simultaneously with the display of a first one of the virtual characters moving a virtual weapon in the second virtual scene and a second one of the sounds is output by the one or more speakers simultaneously with the display of the second one of the virtual characters moving its foot in the second virtual scene. The methods, described herein, apply equally to the second virtual scene.

In an embodiment, instead of the virtual character 150 moving its left foot to output the sounds 166 simultaneously with the movement of the left foot, the virtual character 150 moves its right foot to output the sounds 166 simultaneously with the movement of the right foot.

FIG. 2 is a diagram of an embodiment of a system 200 to illustrate the method for generating and applying audio-based basis functions. The system 200 includes an encoder 202, a time shifter 204, a summer 206, an audio dataset ma, another audio dataset mb, a weight 1a, a weight 2a and so on until a weight pa, multiple weights 1b through pb, basis functions BF1a, BF2a and so on until the basis function BFpa, and basis functions BF1b through BFqb, and an audio data output 208, where p is a positive integer, and q is a positive integer. The basis functions BF1a, BF2a and so on until the basis function BFpa, and basis functions BF1b through BFqb are represented as basis functions 203. As an example, none of the basis functions BF1a through BFpa and BF1b through BFqb is a sine waveform or a cosine waveform. For example, the basis function BFpa is not a sinusoidal function and the basis function BFqb is not a sinusoidal function. The weights 1a through pa and 1b through pb are represented as weights 205. As an example, each of the weights 1a through qb are different from each other. To illustrate, the weight pa is greater than or less than the weight 1a and the weight q1 is greater than or less than the weight qb. As another example, one or more of the weights 1a through qb are equal to each other. To illustrate, the weight pa is equal to the weight 1a and the weight qb is equal to the weight 1b.

As an example, the encoder 202, the time shifter 204, and the summer 206 are components of the server system, and the audio datasets ma and mb, the weights 1a through pa, the weights 1b through pb, the basis functions BF1a through pa, and the basis functions BF1b through BFqb are stored in the one or more memory devices of the server system. To illustrate, each of the encoder 202, the time shifter 204, and the summer 206 is implemented as hardware or software or a combination thereof. In the example, a network interface controller (NIC), such as a network interface card, of the server system applies a network communication protocol, such as a transmission control protocol over Internet protocol (TCP/IP), to the audio data output 208 to generate communication packets having the audio data output 208, and sends the communication packets via the computer network to the client device. Further, in the example, a NIC of the client device receives the communication packets and applies the network communication protocol to the communication packets to extract the audio data output 208. In the example, the NIC provides the audio data output 208 to the one or more speakers of the client device, and the one or more speakers of the client device output sounds based on the audio data output 208. To illustrate, the one or more speakers of the client device convert the audio data output 208 from an electronic signal, such as a digital signal or digital data, to sounds.

Further, in the example, the audio data output 208 is output as sounds from a virtual object, such as the virtual object 112 or 108 or 154 or 158, in a virtual scene, such as the virtual scene 102 or 152. To illustrate, the one or more processors of the server system provide an instruction to the client device to output the audio data output 208 as sounds simultaneously with movement of the virtual object 108 or 112 or 154 or 158 or another virtual object. In the illustration, upon receiving the instruction, the one or more processors of the client device control the one or more speakers of the client device to provide the audio data output 208 as sounds simultaneously with movement of the virtual object 108 or 112 or 154 or 158 or the other virtual object in the virtual scene.

In the example, the weights 1a through pa and 1b through qb are received by the one or more processors of the server system from a user via an input device that is coupled to the one or more processors. To illustrate, the weights 1a through pa and 1b through qb are received according to user inputs, which include one or more selections of one or more buttons of the input device. In the illustration, the user inputs are received from a third user, or the second user, or the user 1. Examples of an input device, as used herein, include a hand-held controller, a keyboard, a stylus, a mouse, a touchpad, and a touchscreen.

As another example, the encoder 202, the time shifter 204, and the summer 206 are components of the client device, the audio datasets ma and mb are stored in the one or more memory devices of the server system, and the weights 1a through pa, the weights 1b through pb, the basis functions BF1a through pa, and the basis functions BF1b through BFqn are stored in one or more memory devices of the client device. In the example, the NIC of the server system applies the network communication protocol to the audio datasets ma and mb to generate communication packets having the audio datasets ma and mb, and sends the communication packets via the computer network to the client device. Further, in the example, the NIC of the client device receives the communication packets and applies the network communication protocol to the communication packets to obtain the audio datasets ma and mb. In the example, the NIC provides the audio datasets ma and mb to the encoder 202 of the client device. Further, in the example, the summer 206 provides the audio data output 208 to the one or more speakers of the client device.

As an example, each of the encoder 202, the time shifter 204, and the summer 206 is a portion of a computer program that is executed by the one or more processors of the server system. As another further illustration, the encoder 202 is implemented as a first FPGA, the time shifter 204 is implemented as a second FPGA, and the summer 206 is implemented as a third FPGA. As yet another further illustration, the encoder encoder is a first computer program, the time shifter 204 is a second computer program, and the summer 206 is the third computer program.

An example of the audio dataset ma is audio data of the audio frames based on which the sound 111 (FIG. 1A) is output to be associated with the virtual sword 110, or is audio data of the audio frames based on which the sound 113 (FIG. 1A) is output to be associated with the virtual character 112 or the right foot of the virtual character 112. To illustrate, the one or more speakers of the client device convert the audio dataset ma from an electronic signal, such as a digital signal or digital data, to the sounds 111 or 113, each of which is an analog form, such as sound waves of vibrations traveling through air. An example of the audio dataset mb is audio data of the audio frames based on which the sound 164 is output to be associated with the virtual knife 156 (FIG. 1B) or is audio data of the audio frames based on which the sound 166 is output to be associated with the virtual character 158 or the left foot of the virtual character 158. To illustrate, the one or more speakers of the client device convert the audio dataset mb from an electronic signal, such as a digital signal or digital data, to the sounds 164 or 166, each of which is an analog form, such as sound waves of vibrations traveling through air.

As an example, each of the weights 1a through pa and 1b through qb is a volume data, such as amplitudes or values or magnitudes. To illustrate, the weight 1a is a first value of volume, the weight 2a is a second value of volume, and so on until the weight pa is a p^{th} value of volume. Also, as another illustration, the weight 1b is a first value of volume, the weight 2b is a second value of volume, and so on until the weight qb is a q^{th} value of volume.

The time shifter 204 includes multiple functions Fx1a, Fx2a, and so on until a function Fxpa, and Fx1b until a function Fxqb. As an example, each function Fx1a, Fx2a, until the function Fxpa, and function Fx1b until the function Fxqb is applied to achieve a respective time shift, such as a time delay or a time lead. As an example, one or more of the functions Fx1a through Fxqb are different from each other. To illustrate, the function Fx1a applies a greater or lesser time shift than that applied by the function Fxpa and the function Fxq1 applies a greater or lesser time shift than that applied by the function Fxqb. As another example, one or more of the functions Fx1a through Fxqb are equal to each other. To illustrate, the function Fx1a applies an equal amount of time shift as that applied by the function Fxpa and the function Fx1b applies an equal amount of time shift as that applied by the function Fxqb. As an example, one or more of the functions Fx1a through Fxqb are received from a user via the input device.

The summer 206 includes multiple adders AD1a, AD2a, and so on until an adder ADpa. The summer 206 also includes adders AD1b and so until an adder ADqb. Each adder of the summer 206 is hardware or software or a combination thereof. For example, the adder AD1a is a first FPGA, the adder AD2a is a second FPGA, and so on until the adder ADpa is a p^{th} FPGA. Further in the example, the adder AD1b is a (p+1)th FPGA and so on until the adder ADqb is a (p+q)^{th} FPGA.

The encoder 202 is coupled to the time shifter 204, which is coupled to the summer 206. Within the summer 206, the adder AD1a is coupled to the adder AD2a, which is coupled to the adder ADpa. The adder ADpa is coupled to the adder AD1b, which is coupled to the adder ADqb. Also, the weights 205 and the basis functions 203 are stored in one or more memory devices of the server system or the client device.

The encoder 202 receives, such as accesses or obtains, the audio datasets ma and mb and encodes the audio datasets ma and mb to output the basis functions 203. For example, the encoder 202 requests the one or more processors of the server system or the client device for the audio datasets ma and mb. In the example, the one or more processors of the client device access the audio datasets ma and mb from the one or more memory devices of the client device or the one or more processors of the server system access the audio datasets ma and mb from the one or more memory devices of the server system. Also, in the example, the encoder 202 receives the audio datasets ma and mb from the one or more processors in response to the request, and processes, such as applies principal component analysis (PCA) to, the audio datasets ma and mb to generate the basis functions 203. To illustrate, the encoder 202 divides the audio dataset ma into the basis functions BF1a through BFpa based on movement of the virtual sword 110 (FIG. 1A) from the position A to the position D or movement of the right foot of the virtual character 112 from the position a to the position d (FIG. 1A). In the illustration, the basis function BF1a is audio data that is to be output as a first portion of the sounds 111 (FIG. 1A) simultaneously with a display of the movement of the virtual sword 110 from the position A to the position B or is audio data that is to be output as a first portion of the sounds 113 (FIG. 1A) simultaneously with a display of the movement of the right foot of the virtual character 112 from the position a to the position b. Further, in the illustration, the basis function BF2a is audio data that is to be output as a second portion of the sounds 111 simultaneously with a display of the movement of the virtual sword 110 from the position B to the position C or is audio data that is to be output as a second portion of the sounds 113 simultaneously with a display of the movement of the right foot of the virtual character 112 from the position b to the position c. Also, in the illustration, the basis function BFpa is audio data that is to be output as a p^{th} portion of the sounds 111 simultaneously with a display of the movement of the virtual sword 110 from the position C to the position D or is audio data that is to be output as a p^{th} portion of the sounds 113 simultaneously with a display of the movement of the right foot of the virtual character 112 from the position c to the position d.

As another illustration, the encoder 202 divides the audio dataset mb into the basis functions BF1b through BFqb based on movement of the virtual knife 156 (FIG. 1B) from the position P1 to the position P4 or movement of the left foot of the virtual character 158 from the position PO1 to the position PO4 (FIG. 1B). In the illustration, the basis function BF1b is audio data that is to be output as a first portion of the sounds 164 (FIG. 1B) simultaneously with a display of the movement of the virtual knife 156 from the position P1 to the position P2 or is audio data that is to be output as a first portion of the sounds 166 (FIG. 1B) simultaneously with a display of the movement of the left foot of the virtual character 158 from the position PO1 to the position PO2. Further, in the illustration, the basis function BF2b is audio data that is to be output as a second portion of the sounds 164 simultaneously with a display of the movement of the virtual knife 156 from the position P2 to the position P3 or is audio data that is to be output as a second portion of the sounds 166 simultaneously with a display of the movement of the left foot of the virtual character 158 from the position PO2 to the position PO3. Also, in the illustration, the basis function BFqb is audio data that is to be output as a q^{th} portion of the sounds 164 simultaneously with a display of the movement of the virtual knife 156 from the position P3 to the position P4 or is audio data that is to be output as a q^{th} portion of the sounds 166 simultaneously with a display of the movement of the left foot of the virtual character 158 from the position PO3 to the position PO4. An example of a basis function is audio data that can be represented as an audio waveform. To illustrate, the basis function is represented as the audio waveform that varies a function of time.

Upon receiving the weights 205, one or more processors, such as the one or more processors of the server system or of the client device, apply the weights 205 to the basis functions 203 to output weighted basis functions 210. For example, the one or more processors multiply the basis function BF1a with the weight 1a to calculate a weighted basis function WBF1a, multiply the basis function BF2a with the weight 2a to calculate a weighted basis function WBF2a, and so on until the weight pa is multiplied with the basis function BFpa to calculate a weighted basis function WBFpa. Also, in the example, the one or more processors multiply the weight 1b with the basis function BF1b to calculate a weighted basis function WBF1b and so on until the weight qb is multiplied with the basis function BFqb to calculate a weighted basis function WBFqb.

The time shifter 204 receives the weighted basis functions 210 and applies the functions Fx1a through Fxpa and Fx1b through Fxqb to output multiple time-shifted basis functions 212. For example, the time shifter 204 time shifts, such as adds a time delay to or removes a time lead to, the weighted basis function WBF1a to output a time-shifted basis function TBF1a. Also, in the example, the time shifter 204 time shifts the weighted basis function WBF2a to output a time-shifted basis function TBF2a and so on until the weighted basis function WBFpa is time shifted the output a time-shifted basis function TBFpa. Moreover, in the example, the time shifter 204 time shifts the weighted basis function WBF1b to output a time-shifted basis function TBF1b and so on until the weighted basis function WBFqb is time shifted the output a time-shifted basis function TBFqb. As another example, the time shifter 204 time shifts one or more of the weighted basis functions WBF1a through WBFqb without time shifting remaining ones of the weighted basis functions WBF1a through WBFqb. To illustrate, the time shifter 204 time shifts the weighted basis function WBF1a and does not time shift the remaining weighted basis functions WBF2a through WBFqb. As another illustration, the time shifter 204 time shifts the weighted basis functions WBF1a, and WBF1b through WBFqb, and does not time shift the remaining weighted basis functions WBF2a through WBFpa. Each function Fx1a through Fxpa and Fx1b through Fxqb is sometimes referred to herein as a time shift.

The functions Fx1a through Fxpa and Fx1b through Fxqb are received by the one or more processors of the server system or the client device from an input device that is coupled to the one or more processors. To illustrate, the functions Fx1a through Fxpa and Fx1b through Fxqb are received according to user inputs, which include one or more selections of one or more buttons of the input device. To further illustration, the one or more selections indicate whether to apply one or more of the functions Fx1a through Fxqb to a respective one of the weighted basis functions WBF1a through WBFqb. In the illustration, the user inputs are received from the third user, or the second user, or the user 1. Examples of the input device are provided above.

The summer 206 adds two or more of the time shifted basis functions TBF1a through TBFqb to generate the audio data output 208. For example, the adders AD1a and AD2a add the time-shifted basis functions TBF1a and TBF2a to determine a first group of audio data output, and the first group is an example of the audio data output 208. Further, in the example, the adders AD1a and AD1b add the time-shifted basis functions TBF1a and TBF1b to determine a second group of audio data output, and the second group is an example of the audio data output 208. As yet another example, the adders AD1a and AD1b add the time-shifted basis functions TBF1a and TBF1b to generate a third group of audio data output, and the third group is an example of the audio data output 208. As another example, the adders AD1a through ADpa and AD1b through ADqb add the time-shifted basis functions TBF1a through TBFqb to generate a fourth group of audio data output, and the fourth group is an example of the audio data output 208. As an example, a selection of which of one or more of the adders AD1a through ADqb to apply to a respective one of the time-shifted basis functions TBF1a through TBFqb are received from the user via the input device.

FIG. 3 is a diagram of an embodiment of a system 300 to illustrate further details of the method for generating and applying audio-based basis functions. The system 300 includes a server system 302 and an encoder 306. The encoder 306 is an example of the encoder 202 (FIG. 2). The encoder 306 includes a position analyzer 308, a time analyzer 310, and a basis function identifier 312.

The one or more memory devices of the server system 302 stores the audio datasets ma and mb and a metadata set 304. The metadata set 304 includes metadata na and metadata nb. Examples of metadata include a shape of a virtual object to be displayed or displayed in a virtual scene, locations of the virtual object in the virtual scene, an identifier of the virtual scene, time of occurrences of the locations, and an identifier of the virtual object. To illustrate, the metadata na is associated with, such as linked to or having a one-to-one relationship with, the audio data ma, and the metadata nb associated with, such as linked to or having a one-to-one relationship with, the audio data mb. To further illustrate, the metadata na includes shape data identifying a shape of the virtual sword 110 (FIG. 1A), shape data identifying a shape of the virtual character 108 (FIG. 1A), shape data identifying a shape of the virtual character 112 (FIG. 1A), the positions A through D of the virtual sword 110, the positions a through d of the right foot of the virtual character 112 at the location 116, an identifier of the virtual scene 102 (FIG. 1A), an identifier of the virtual sword 110, an identifier of the virtual character 108, an identifier of the virtual character 112, an identifier of the right foot of the virtual character 112, an identifier of the front portion of the right foot of the virtual character 112, an identifier of the middle portion of the right foot of the virtual character 112, an identifier of the back portion of the right foot of the virtual character 112, the times ta through td, and the times tA through tD. As another further illustration, the metadata nb includes shape data identifying a shape of the virtual knife 156 (FIG. 1B), shape data identifying a shape of the virtual character 158 (FIG. 1B), shape data identifying a shape of the virtual character 154 (FIG. 1B), the positions P1 through P4 of the virtual knife 156, the positions a through d of the left foot of the virtual character 158 at the location 162, an identifier of the virtual scene 152 (FIG. 1B), an identifier of the virtual knife 156, an identifier of the virtual character 158, an identifier of the virtual character 154, an identifier of the left foot of the virtual character 158, an identifier of the front portion of the left foot of the virtual character 158, an identifier of the middle portion of the left foot of the virtual character 158, an identifier of the back portion of the left foot of the virtual character 158, the times tP1 through tP4, and the times tPO1 through tPO4. As an example, an identifier includes a series of alphanumeric characters.

Each of the position analyzer 308, the time analyzer 310, and the basis function identifier 312 is hardware or software or a combination thereof. For example, the position analyzer 308 is a first FPGA, the time analyzer 310 is a second FPGA, and the basis function identifier 312 is a third FPGA. As another example, the position analyzer 308 is a first computer program, the time analyzer 310 is a second computer program, and the basis function identifier 312 is a third computer program. As yet another example, the position analyzer 308 is a first portion of the computer program, the time analyzer 310 is a second portion of the computer program, and the basis function identifier 312 is a third portion of the computer program.

The position analyzer 308 and the time analyzer 310 are coupled to the server system 302. The basis function identifier 312 is coupled to the position analyzer 308, and the time analyzer 310.

The position analyzer 308 obtains the metadata na based on the association between the metadata na and the audio dataset ma from the server system 302, and parses the metadata na to output movements of the virtual sword 110 between two consecutive ones of the positions A, B, C, and D and movements of the virtual character 112 between two consecutive ones of the positions a, b, c, and d. For example, the position analyzer 308 divides movement data of the virtual sword 110 to be displayed or displayed in the virtual scene 102 with output of the sounds 111 into a first set of movements from the position A to the position B, a second set of movements from the position B to the position C, and a third set of movements from the position C to the position D. Moreover, in the example, the position analyzer 308 divides movement data of the right foot of the virtual character 112 to be displayed or displayed in the virtual scene 102 at the location 116 with output of the sounds 113 into a primary set of movements from the position a to the position b, a secondary set of movements from the position b to the position c, and a tertiary set of movements from the position c to the position d. In the example, the movement data of the right foot is divided based on the identifiers of the front, middle, and back portions of the right foot. To illustrate, the position analyzer 308 determines that the movement data indicates a beginning of movement of the front portion, identified by a first identifier, at the position a and an end of the movement of the front portion at the position b to determine the first set of movement from the position a to the position b. Also in the illustration, the position analyzer 308 determines that the movement data indicates a beginning of movement of the middle portion, identified by a second identifier, at the position b and an end of the movement of the middle portion at the position c to determine the second set of movement from the position b to the position c. Further, in the illustration, the position analyzer 308 determines that the movement data indicates a beginning of movement of the back portion, identified by a third identifier, at the position c and an end of the movement of the back portion at the position d to determine the third set of movement from the position c to the position d. The position analyzer 308 provides the positions a through d, the first through third sets of movements from the position a to the position d, the positions A through D, and the primary through tertiary sets of movements from the position A to the position D to the basis function identifier 312. The position analyzer 308 also provides identifiers of each virtual object, such as each of the front, middle, and back portions of the right foot, in the virtual scene 102 to the basis function identifier 312.

Similarly, the position analyzer 308 obtains the metadata nb based on the association between the metadata nb and the audio dataset mb from the server system 302, and parses the metadata nb to output movements between two consecutive ones of the positions P1 through P4 of the virtual knife 156 and movements between two consecutive ones of the positions PO1 through PO4 of the left foot of the virtual character 158 (FIG. 1B). For example, the position analyzer 308 divides movement data of the virtual knife 156 to be displayed or displayed in the virtual scene 152 with output of the sounds 164 into a first set of movements from the position P1 to the position P2, a second set of movements from the position P2 to the position P3, and a third set of movements from the position P3 to the position P4. Moreover, in the example, the position analyzer 308 divides movement data of the left foot of the virtual character 158 to be displayed or displayed in the virtual scene 152 at the location 162 with output of the sounds 166 into a primary set of movements of the left foot from the position PO1 to the position PO2, a secondary set of movements of the left foot from the position PO2 to the position PO3, and a tertiary set of movements of the left foot from the position PO2 to the position PO3. In the example, the movement data of the left foot is divided based on the identifiers of the front, middle, and back portions of the left foot. To illustrate, the position analyzer 308 determines that the movement data indicates a beginning of movement of the front portion, identified by a first identifier, at the position PO1 and an end of the movement of the front portion at the position PO2 to identify the primary set of movements. Also in the illustration, the position analyzer 308 determines that the movement data indicates a beginning of movement of the middle portion, identified by a second identifier, at the position PO2 and an end of the movement of the middle portion at the position PO3 to identify the secondary set of movements. Further, in the illustration, the position analyzer 308 determines that the movement data indicates a beginning of movement of the back portion, identified by a third identifier, at the position PO3 and an end of the movement of the back portion at the position PO4 to identify the tertiary set of movements.

The position analyzer 308 provides the positions P1 through P4, the first through third sets of movements from the position P1 to the position P4, the positions PO1 through PO4, and the primary through tertiary sets of movements from the position PO1 to the position PO4 to the basis function identifier 312. The position analyzer 308 also provides identifiers of each virtual object, such as the front, middle, and back portions of the left foot, in the virtual scene 152 to the basis function identifier 312.

The time analyzer 310 obtains the metadata na based on the association between the metadata na and the audio dataset ma from the server system 302, and parses the metadata na to output time periods between two consecutive ones of the times ta through td and time periods between two consecutive ones of the times tA through tD. For example, the time analyzer 310 divides time data, such as time period data, of movement of the virtual sword 110 from the position A to the position D to be displayed or displayed in the virtual scene 102 with output of the sounds 111 into a first time period from the time tA to the time tB, a second time period from the time tB to the time tC, and a third time period from the time tC to the time tD. Moreover, in the example, the time analyzer 310 divides time data, such as time period data, of movement of the right foot of the virtual character 112 to be displayed or displayed in the virtual scene 102 at the location 116 with output of the sounds 113 into a primary time period from the time ta to the time tb, a secondary time period from the time tb to the time to, and a tertiary time period from the time te to the time td. In the example, the time data at which the right foot moves from the position a to the position d is divided based on the identifiers of the front, middle, and back portions of the right foot. To illustrate, the time analyzer 310 determines that movement data of the movement of the right foot indicates a beginning of movement of the front portion, identified by a first identifier, at the position a and an end of the movement of the front portion at the position b, and extracts a portion of the time data from the time ta at which the position a occurs to the time tb at which the position b occurs to determine the primary time period. Also in the illustration, the time analyzer 310 determines that the movement data indicates a beginning of movement of the middle portion, identified by a second identifier, at the position b and an end of the movement of the middle portion at the position c, and extracts a portion of the time data from the time tb at which the position b occurs to the time te at which the position c occurs to determine the secondary time period. Further, in the illustration, the time analyzer 310 determines that the movement data indicates a beginning of movement of the back portion, identified by a third identifier, at the position c and an end of the movement of the back portion at the position d, and extracts a portion of the time data from the time te at which the position c occurs to the time td at which the position d occurs to determine the tertiary time period. The time analyzer 310 provides the times ta through td, the primary through tertiary time periods from the time ta to the time td, the times tA through tD, and the first through third periods of time from the time tA to the time tD to the basis function identifier 312.

The time analyzer 310 obtains the metadata nb based on the association between the metadata nb and the audio dataset mb from the server system 302, and parses the metadata nb to output time periods between two consecutive ones of the times tP1 through tP4 and time periods between two consecutive ones of the times tPO1 through tPO4. For example, the time analyzer 310 divides time data, such as time period data, of movement of the virtual knife 156 from the position P1 to the position P4 to be displayed or displayed in the virtual scene 152 with output of the sounds 164 into a first time period from the time tP1 to the time tP2, a second time period from the time tP2 to the time tP3, and a third time period from the time tP3 to the time tP4. Moreover, in the example, the time analyzer 310 divides time data, such as time period data, of movement of the left foot of the virtual character 158 to be displayed or displayed in the virtual scene 152 at the location 162 with output of the sounds 166 into a primary time period from the time tPO1 to the time tPO2, a secondary time period from the time tPO2 to the time tPO3, and a tertiary time period from the time tPO2 to the time tPO3. In the example, the time data at which the left foot moves from the position PO1 to the position PO4 is divided based on the identifiers of the front, middle, and back portions of the left foot. To illustrate, the time analyzer 310 determines that movement data of the movement of the left foot indicates a beginning of movement of the front portion, identified by a first identifier, at the position a and an end of the movement of the front portion at the position b, and extracts a portion of the time data from the time tPO1 at which the position PO1 occurs to the time tPO2 at which the position PO2 occurs to determine the primary time period. Also in the illustration, the time analyzer 310 determines that the movement data indicates a beginning of movement of the middle portion, identified by a second identifier, at the position PO2 and an end of the movement of the middle portion at the position PO3, and extracts a portion of the time data from the time tPO2 at which the position PO2 occurs to the time tPO3 at which the position PO3 occurs to determine the secondary time period. Further, in the illustration, the time analyzer 310 determines that the movement data indicates a beginning of movement of the back portion, identified by a third identifier, at the position PO2 and an end of the movement of the back portion at the position PO3, and extracts a portion of the time data from the time tPO3 at which the position PO3 occurs to the time tPO4 at which the position PO4 occurs to determine the tertiary time period. The time analyzer 310 provides the times tP1 through tP4, the first through third time periods, the times tPO1 through tPO4, and the primary through tertiary time periods to the basis function identifier 312.

The basis function identifier 312 receives the metadata na, the metadata nb, sets of movements between any two consecutive positions of each of the virtual objects in the virtual scene 102, sets of movements between any two consecutive positions of each of the virtual objects in the virtual scene 152, time periods of occurrences of movements between the positions of the virtual objects in the virtual scene 102, and time periods of occurrences of movements between the positions of the virtual objects in the virtual scene 152. The basis function identifier 312 parses the audio data ma and the audio data mb based on the sets of movements of the virtual objects in the virtual scenes 102 and 152, the metadata na and nb, and the time periods of occurrences of the movements of the virtual objects in the virtual scenes 102 and 152 to output the basis functions BF1a, BF2a, and so on until the basis function BFqb. For example, the basis function identifier 312 obtains the audio dataset ma from the server system 302 and divides the audio dataset ma into the basis functions BF1a through BFpa based on the primary through tertiary time periods from the times ta through td and the primary through tertiary movements from the positions a through d. To illustrate, the basis function identifier 312 determines that the audio dataset ma is to be divided into a first portion, a second portion, and a third portion. In the illustration, the first portion of the audio dataset ma is to be output or output as a portion of the sounds 113 (FIG. 1A) simultaneously with a display of movement of the right foot of the virtual character 112 from the position a at the time ta to the position b at the time tb. Moreover, in the illustration, the second portion of the audio dataset ma is to be output or output as another portion of the sounds 113 simultaneously with a display of movement of the right foot of the virtual character 112 from the position b at the time tb to the position e at the time tc. Also, in the illustration, the third portion of the audio dataset ma is to be output or output as yet another portion of the sounds 113 simultaneously with a display of movement of the right foot of the virtual character 112 from the position c at the time te to the position d at the time td. In the illustration, the basis function identifier 312 determines that the first portion is the basis function BF1a, the second portion is the basis function BF2a, and the third portion is the basis function BFpa.

As another example, the basis function identifier 312 obtains the audio dataset ma from the server system 302 and divides the audio dataset ma into the basis functions BF1a through BFpa based on the first through third sets of times from the time tA to the time tD and the first through third sets of movements from the position A to the position D. To illustrate, the basis function identifier 312 determines that the audio dataset ma is to be divided into a first portion, a second portion, and a third portion. In the illustration, the first portion of the audio dataset ma is to be output or output as a portion of the sounds 111 (FIG. 1A) simultaneously with a display of movement of the virtual sword 110 from the position A at the time tA to the position B at the time tB. Moreover, in the illustration, the second portion the audio dataset ma is to be output or output as another portion of the sounds 111 with a display of movement of the virtual sword 110 from the position B at the time tB to the position C at the time tC. Also, in the illustration, the third portion of the audio dataset ma is to be output or output as yet another portion of the sounds 111 simultaneously with a display of movement of the virtual sword 110 from the position C at the time tC to the position D at the time tD. In the illustration, the basis function identifier 312 determines that the first portion is the basis function BF1a, the second portion is the basis function BF2a, and the third portion is the basis function BFpa.

As yet another example, the basis function identifier 312 obtains the audio dataset mb from the server system 302 and divides the audio dataset mb into the basis functions BF1b through BFqb based on the primary through tertiary time periods of occurrences of movements from the time tPO1 to the time tPO4 and the primary through tertiary sets of movements from the position PO1 to the position PO4. To illustrate, the basis function identifier 312 determines that the audio dataset mb is to be divided into a first portion, a second portion, and a third portion. In the illustration, the first portion is to be output or output as a portion of the sounds 166 (FIG. 1B) simultaneously with a display of movement of the left foot of the virtual character 158 from the position PO1 at the time tPO1 to the position PO2 at the time tPO2. Moreover, in the illustration, the second portion is to be output or output as another portion of the sounds 166 simultaneously with a display of movement of the left foot of the virtual character 158 from the position PO2 at the time tPO2 to the position PO3 at the time tPO3. Also, in the illustration, the third portion is to be output or output as yet another portion of the sounds 166 simultaneously with a display of movement of the left foot of the virtual character 158 from the position PO3 at the time tPO3 to the position PO4 at the time tPO4. In the illustration, the basis function identifier 312 determines that the first portion is the basis function BF1b, the second portion is the basis function BF2b, and the third portion is the basis function BFqb.

As still another example, the basis function identifier 312 obtains the audio dataset mb from the server system 302 and divides the audio dataset mb into the basis functions BF1b through BFqb based on the first through third time periods of occurrences from the time tP1 to the time tP4 and the first through third sets of movements from the position P1 to the position P4. To illustrate, the basis function identifier 312 determines that the audio dataset mb is to be divided into a first portion, a second portion, and a third portion. In the illustration, the first portion is to be output or output as a portion of the sounds 164 (FIG. 1B) simultaneously with a display of movement of the virtual knife 156 from the position P1 at the time tP1 to the position P2 at the time tP2. Moreover, in the illustration, the second portion is to be output or output as another portion of the sounds 164 simultaneously with a display of movement of the virtual knife 156 from the position P2 at the time tP2 to the position P3 at the time tP3. Also, in the illustration, the third portion is to be output or output as yet another portion of the sounds 164 simultaneously with a display of movement of the virtual knife 156 from the position P3 at the time tP3 to the position P4 at the time tP4. In the illustration, the basis function identifier 312 determines that the first portion is the basis function BF1b, the second portion is the basis function BF2b, and the third portion is the basis function BFqb.

FIG. 4 is a diagram of an embodiment of a system 400 to illustrate use of the summer 206 with a switch system 402. The system 400 includes the summer 206, the switch system 402, a dataset similarity analyzer 405, and the server system 302. The switch system 402 includes multiple switches Swla, SW2a and so on until a switch SWpa, and switches SW1b until a switch SWqb. Also, the switch system 402 includes a switch controller (CTRL) 404.

Each of the switches Swla, SW2a and so on until a switch SWpa, the switches SW1b until a switch SWqb, the switch controller 404, and the dataset similarity analyzer 405 is software or hardware or a combination thereof. For example, the switch controller 404 is a first FPGA, the switch SW1a is a first transistor, the switch SW2a is a second transistor and so on until the switch SWpa is a p^{th} transistor, the switch SW1b is a (p+1)th transistor until the switch SWqb is a q^{th} transistor, and the dataset similarity analyzer 405 is a second FPGA. As another example, the switch controller 404 is a first computer program, the switches SW1a through SWpa and the switches SW1b through SWqb are portions of a second computer program, and the dataset similarity analyzer 405 is a third computer program. As yet another example, the switch controller 404 is a first portion of a first computer program, the dataset similarity analyzer 405 is a second portion of the computer program, and the switches SW1a through SWpa and the switches SW1b through SWqb are remaining portions of the computer program.

The dataset similarity analyzer 405 is coupled to the server system 302, the encoder 202, and the switch controller 404. The switch controller 404 is coupled to each of the switches SW1a through SWpa and the switches SW1b through SWqb. The switches SW1a through SWpa and the switches SW1b through SWqb are coupled to the summer 206. For example, the switch SW1a is coupled to the adder AD1a, the switch SW2a is coupled to the adder AD2a, and so on until the switch SWpa is coupled to the adder ADpa. Also in the example, the switch SW1b is coupled to the adder AD1b and the switch SWqb is coupled to the adder ADqb.

The dataset similarity analyzer 405 receives the basis functions BF1a through BFpa, the basis functions BF1b through BFqb, the metadata na and nb, and the identifiers of the virtual objects in the virtual scenes 102 and 152 from the encoder 202, and determines similarity between two or more of the basis functions BF1a through BFqb based on the identifiers. For example, the dataset similarity analyzer 405 determines that the basis function BF1a is similar to the basis function BF1b upon determining that the basis function BF1a corresponds to, such as has a unique relationship with or is linked with, the identifier of the front portion of the right foot of the virtual character 112 (FIG. 1A) and the basis function BF1b corresponds to, such as has a unique relationship with or is linked with, the identifier of the front portion of the left foot of the virtual character 158 (FIG. 1B). In the example, the dataset similarity analyzer 405 also determines that the basis function BF1a is similar to the basis function BF1b upon determining that a shape of the front portion of the right foot of the virtual character 112 is similar to, such as having substantially the same shape or the same shape, as that of the front portion of the left foot of the virtual character 158. To illustrate, the dataset similarity analyzer 405 determines based on the identifier of the front portion of the right foot of the virtual character 112 and the identifier of the front portion of the left foot of the virtual character 158 that the identifiers are of the front portions of foots and therefore, the basis functions BF1a and BF1b corresponding to the identifiers are similar to each other. In the illustration, the dataset similarity analyzer 405 determines that shapes of the front portions of the right foot of the virtual character 112 and left foot or the virtual character 158 are similar when front portions have curvatures within a predetermined range from each other. In the example, the dataset similarity analyzer 405 determines that the remaining basis functions BF2a through BFqb are not similar to the basis functions BF1a and BF1b.

As another example, the dataset similarity analyzer 405 determines that the basis function BF2a is similar to the basis function BF2b upon determining that the basis function BF2a corresponds to, such as has a unique relationship with or is linked with, the identifier of the middle portion of the right foot of the virtual character 112 and the basis function BF2b corresponds to, such as has a unique relationship with or is linked with, the identifier of the middle portion of the left foot of the virtual character 158. In the example, the dataset similarity analyzer 405 also determines that the basis function BF2a is similar to the basis function BF2b upon determining that a shape of the middle portion of the right foot of the virtual character 112 is similar to, such as having substantially the same shape or the same shape, as that of the middle portion of the left foot of the virtual character 158. To illustrate, the dataset similarity analyzer 405 determines based on the identifier of the middle portion of the right foot of the virtual character 112 and the identifier of the middle portion of the left foot of the virtual character 158 that the identifiers are of the middle portions of foots and therefore, the basis functions BF2a and BF2b corresponding to the identifiers are similar to each other. In the illustration, the dataset similarity analyzer 405 determines that shapes of the middle portions of the right foot of the virtual character 112 and left foot of the virtual character 158 are similar when middle portions have curvatures within a predetermined range from each other. In the example, the dataset similarity analyzer determines that the remaining basis functions BF1a, BF3a through BF1b, and BF3a through BFqb are not similar to the basis functions BF2a and BF2b.

As yet another example, the dataset similarity analyzer 405 determines that the basis function BFpa is similar to the basis function BFqb upon determining that the basis function BFpa corresponds to, such as has a unique relationship with or is linked with, the identifier of the back portion of the right foot of the virtual character 112 and the basis function BFqb corresponds to, such as has a unique relationship with or is linked with, the identifier of the back portion of the left foot of the virtual character 158. In the example, the dataset similarity analyzer 405 also determines that the basis function BFpa is similar to the basis function BFqb upon determining that a shape of the back portion of the right foot of the virtual character 112 is similar to, such as having substantially the same shape or the same shape, as that of the back portion of the left foot of the virtual character 158. To illustrate, the dataset similarity analyzer 405 determines based on the identifier of the back portion of the right foot of the virtual character 112 and the identifier of the back portion of the left foot of the virtual character 158 that the identifiers are of the back portions of foots and therefore, the basis functions BFpa and BFqb corresponding to the identifiers are similar to each other. In the illustration, the dataset similarity analyzer 405 determines that shapes of the back portions of the right foot of the virtual character 112 and left foot or the virtual character 158 are similar when back portions have curvatures within a predetermined range from each other. In the example, the dataset similarity analyzer determines that the remaining basis functions BF1a through BF(p−1)a and the basis functions BF1b through BF(q−1)b are not similar to the basis functions BFpa and BFqb.

The similarity between two or more of the basis functions BF1a through BFqb is determined to indicate to the switch controller 404 that two or more of the switches SW1a through SWqb that are to be turned on and remaining of the switches SW1a through SWqb are to be turned off. For example, upon determining that the basis function BF1a is similar to the basis function BF1b and the remaining basis functions BR2a through BFpa and BRq1 through BFqb are not similar to the basis functions BF1a and BF1b, the dataset similarity analyzer 405 sends a signal to the switch controller 404 to indicate to close the switches SW1a and SW1b and open the remaining switches SW2a through SWpa and SW2b through SWqb. Upon receiving the indication, the switch controller 404 controls two or more of the switches SW1a through SWqb according to the indication.

When one of the switches SW1a through SWqb is closed, a respective one of the time-shifted basis functions TBF1a through TBFqb passes via the switch to a respective one of the adders AD1a through ADqb. For example, when the switches SW1a and SW1b are closed and the remaining switches SW2a through SWpa and SWq2 through SWqb are open, the time-shifted basis function TBF1a is transferred via the switch SW1a to the adder AD1a and the time-shifted basis function TBF1b is transferred via the switch SW1b to the adder AD1b. Also, in the example, the remaining time-shifted basis functions are not transferred to the remaining adders AD2a through ADpa and ADq2 through ADqb via the remaining switches SW2a through SWpa and SWq2 through SWqb that are open. In the example, the summer 206 adds the time-shifted basis function TBF1a with the time-shifted basis function TBF1b to provide the audio data output 208.

FIG. 5 illustrates components of an example device 500, such as a client device or a server system, described herein, that can be used to perform aspects of the various embodiments of the present disclosure. This block diagram illustrates the device 500 that can incorporate or can be a personal computer, a smart phone, a video game console, a personal digital assistant, a server or other digital device, suitable for practicing an embodiment of the disclosure. The device 500 includes a CPU 502 for running software applications and optionally an operating system. The CPU 502 includes one or more homogeneous or heterogeneous processing cores. For example, the CPU 502 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. The device 500 can be a localized to a player, such as a user, described herein, playing a game segment (e.g., game console), or remote from the player (e.g., back-end server processor), or one of many servers using virtualization in a game cloud system for remote streaming of gameplay to clients.

A memory 504 stores applications and data for use by the CPU 502. A storage 506 provides non-volatile storage and other computer readable media for applications and data and may include fixed disk drives, removable disk drives, flash memory devices, compact disc-ROM (CD-ROM), digital versatile disc-ROM (DVD-ROM), Blu-ray, high definition-DVD (HD-DVD), or other optical storage devices, as well as signal transmission and storage media. User input devices 508 communicate user inputs from one or more users to the device 500. Examples of the user input devices 508 include keyboards, mouse, joysticks, touch pads, touch screens, still or video recorders/cameras, tracking devices for recognizing gestures, and/or microphones. A network interface 514 allows the device 500 to communicate with other computer systems via an electronic communications network, and may include wired or wireless communication over local area networks and wide arca networks, such as the internet. An audio processor 512 is adapted to generate analog or digital audio output from instructions and/or data provided by the CPU 502, the memory 504, and/or data storage 506. The components of device 500, including the CPU 502, the memory 504, the data storage 506, the user input devices 508, the network interface 514, and an audio processor 512 are connected via a data bus 522.

A graphics subsystem 520 is further connected with the data bus 522 and the components of the device 500. The graphics subsystem 520 includes a graphics processing unit (GPU) 516 and a graphics memory 518. The graphics memory 518 includes a display memory (e.g., a frame buffer) used for storing pixel data for each pixel of an output image. The graphics memory 518 can be integrated in the same device as the GPU 516, connected as a separate device with the GPU 516, and/or implemented within the memory 504. Pixel data can be provided to the graphics memory 518 directly from the CPU 502. Alternatively, the CPU 502 provides the GPU 516 with data and/or instructions defining the desired output images, from which the GPU 516 generates the pixel data of one or more output images. The data and/or instructions defining the desired output images can be stored in the memory 504 and/or the graphics memory 518. In an embodiment, the GPU 516 includes three-dimensional (3D) rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 514 periodically outputs pixel data for an image from the graphics memory 518 to be displayed on the display device 510. The display device 510 can be any device capable of displaying visual information in response to a signal from the device 500, including a cathode ray tube (CRT) display, a liquid crystal display (LCD), a plasma display, and an organic light emitting diode (OLED) display. The device 500 can provide the display device 510 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (Saas). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a GPU since it will be doing a large number of relatively simple mathematical operations (e.g., matrix transformations). Other game engine segments that require fewer but more complex operations may be provisioned with a processing entity associated with one or more higher power CPUS.

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and an input/output (I/O) interface. The client device can be a personal computer (PC), a mobile phone, a netbook, a personal digital assistant (PDA), etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device system, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In an embodiment, although the embodiments described herein apply to one or more games, the embodiments apply equally as well to multimedia contexts of one or more interactive spaces, such as a metaverse.

In one embodiment, the various technical examples can be implemented using a virtual environment via the HMD. The HMD can also be referred to as a virtual reality (VR) headset. As used herein, the term “virtual reality” (VR) generally refers to user interaction with a virtual space/environment that involves viewing the virtual space through the HMD (or a VR headset) in a manner that is responsive in real-time to the movements of the HMD (as controlled by the user) to provide the sensation to the user of being in the virtual space or the metaverse. For example, the user may see a three-dimensional (3D) view of the virtual space when facing in a given direction, and when the user turns to a side and thereby turns the HMD likewise, the view to that side in the virtual space is rendered on the HMD. The HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on the HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, compact disc-read only memories (CD-ROMs), CD-recordables (CD-Rs), CD-rewritables (CD-RWs), magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

It should be noted that in various embodiments, one or more features of some embodiments described herein are combined with one or more features of one or more of remaining embodiments described herein.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for generating and applying audio-based basis functions, comprising:
accessing a first audio dataset, wherein the first audio dataset is associated with a first virtual object from a plurality of virtual objects;
encoding the first audio dataset to output a first plurality of basis functions, wherein each of the first plurality of basis functions is represented as respective one of a plurality of sets of audio data output for a respective one of a plurality of periods of time from the first virtual object;
applying a respective one of a plurality of weights to a respective one of the first plurality of basis functions to output a first plurality of weighted basis functions;
applying a respective one of a plurality of time shifts to a respective one of the first plurality of weighted basis functions to provide a first plurality of time-shifted basis functions; and
adding two or more of the first plurality of time-shifted basis functions to generate a plurality of groups of audio data.

2. The method of claim 1, wherein said applying the respective one of the plurality of weights includes:
applying a first one of the plurality of weights to a first one of the first plurality of basis functions; and
applying a second one of the plurality of weights to a second one of the first plurality of basis functions, wherein the first weight is different from the second weight.

3. The method of claim 1, wherein said applying the plurality of time shifts includes:
applying a first amount of time shift to a first one of the first plurality of weighted basis functions; and
applying a second amount of time shift to a second one of the first plurality of weighted basis functions, wherein the second amount is different from the first amount.

4. The method of claim 1, wherein said adding the two or more of the first plurality of time-shifted basis functions includes adding a first one of the first plurality of time-shifted basis functions with a second one of the first plurality of time-shifted basis functions to output a first one of the plurality of groups of audio data.

5. The method of claim 1, wherein the first plurality of time-shifted basis functions include a first time-shifted basis function, a second time-shifted basis function, and a third time-shifted basis function, wherein said adding the two or more of the plurality of time-shifted basis functions includes:
adding the first time-shifted basis function with the second time-shifted basis function; or
adding the first time-shifted basis function with the third time-shifted basis function; or
adding the second time-shifted basis function with the third time-shifted basis function; or
adding the first time-shifted basis function to the second and third time-shifted basis functions.

6. The method of claim 1, wherein said encoding the first audio dataset includes:
dividing movement of the first virtual object into a plurality of sets of movements of the first virtual object;
dividing a total time period of the movement of the first virtual object into the plurality of periods of time;
determining a first one of the first plurality of basis functions from a first one of the plurality of sets of movements and a first one of the plurality of periods of time;
determining a second one of the first plurality of basis functions from a second one of the plurality of sets of movements and a second one of the plurality of periods of time.

7. The method of claim 1, further comprising:
determining a similarity between the first virtual object and a second virtual object;
accessing a second audio dataset, wherein the second audio dataset is associated with the second virtual object;
encoding the second audio dataset to output a second plurality of basis functions, wherein each of the second plurality of basis functions is represented as respective one of a second plurality of sets of audio data output for a respective one of a second plurality of periods of time from the second virtual object;
applying a respective one of a second plurality of weights to a respective one of the second plurality of basis functions to output a second plurality of weighted basis functions;
applying a respective one of a second plurality of time shifts to a respective one of the second plurality of weighted basis functions to provide a second plurality of time-shifted basis functions; and
adding one or more of the second plurality of time-shifted basis functions with one or more of the first plurality of time-shifted basis functions to modify the plurality of groups of audio data.

8. A system for generating and applying audio-based basis functions, comprising:
a processor configured to:
access a first audio dataset, wherein the first audio dataset is associated with a first virtual object from a plurality of virtual objects;
encode the first audio dataset to output a first plurality of basis functions, wherein each of the first plurality of basis functions is represented as respective one of a plurality of sets of audio data output for a respective one of a plurality of periods of time from the first virtual object;
apply a respective one of a plurality of weights to a respective one of the first plurality of basis functions to output a first plurality of weighted basis functions;
apply a respective one of a plurality of time shifts to a respective one of the first plurality of weighted basis functions to provide a first plurality of time-shifted basis functions; and
add two or more of the first plurality of time-shifted basis functions to generate a plurality of groups of audio data; and
a memory device coupled to the processor.

9. The system of claim 8, wherein to apply the respective one of the plurality of weights, the processor is configured to:
apply a first one of the plurality of weights to a first one of the first plurality of basis functions; and
apply a second one of the plurality of weights to a second one of the first plurality of basis functions, wherein the first weight is different from the second weight.

10. The system of claim 8, wherein to apply the plurality of time shifts, the processor is configured to:
apply a first amount of time shift to a first one of the first plurality of weighted basis functions; and
apply a second amount of time shift to a second one of the first plurality of weighted basis functions, wherein the second amount is different from the first amount.

11. The system of claim 8, wherein to add the two or more of the first plurality of time-shifted basis functions, the processor is configured to:
add a first one of the first plurality of time-shifted basis functions with a second one of the first plurality of time-shifted basis functions to output a first one of the plurality of groups of audio data.

12. The system of claim 8, wherein the first plurality of time-shifted basis functions include a first time-shifted basis function, a second time-shifted basis function, and a third time-shifted basis function, wherein to add the two or more of the first plurality of time-shifted basis functions, the processor is configured to:
add the first time-shifted basis function with the second time-shifted basis function; or
add the first time-shifted basis function with the third time-shifted basis function; or
add the second time-shifted basis function with the third time-shifted basis function; or
add the first time-shifted basis function with the second and third time-shifted basis functions.

13. The system of claim 8, wherein to encode the first audio dataset, the processor is configured to:
divide movement of the first virtual object into a plurality of sets of movements of the first virtual object;
divide a total time period of the movement of the first virtual object into the plurality of periods of time;
determine a first one of the first plurality of basis functions from a first one of the plurality of sets of movements and a first one of the plurality of periods of time;
determine a second one of the first plurality of basis functions from a second one of the plurality of sets of movements and a second one of the plurality of periods of time.

14. The system of claim 8, wherein the processor is configured to:
determine a similarity between the first virtual object and a second virtual object;
access a second audio dataset, wherein the second audio dataset is associated with the second virtual object;
encode the second audio dataset to output a second plurality of basis functions, wherein each of the second plurality of basis functions is represented as respective one of a second plurality of sets of audio data output for a respective one of a second plurality of periods of time from the second virtual object;
apply a respective one of a second plurality of weights to a respective one of the second plurality of basis functions to output a second plurality of weighted basis functions;
apply a respective one of a second plurality of time shifts to a respective one of the second plurality of weighted basis functions to provide a second plurality of time-shifted basis functions; and
add one or more of the second plurality of time-shifted basis functions with one or more of the first plurality of time-shifted basis functions to modify the plurality of groups of audio data.

15. A non-transitory computer-readable medium containing program instructions for generating and applying audio-based basis functions, wherein execution of the program instructions by one or more processors of a computer system causes the one or more processors to carry out operations of:
accessing a first audio dataset, wherein the first audio dataset is associated with a first virtual object from a plurality of virtual objects;
encoding the first audio dataset to output a first plurality of basis functions, wherein each of the first plurality of basis functions is represented as respective one of a plurality of sets of audio data output for a respective one of a plurality of periods of time from the first virtual object;
applying a respective one of a plurality of weights to a respective one of the first plurality of basis functions to output a first plurality of weighted basis functions;
applying a respective one of a plurality of time shifts to a respective one of the first plurality of weighted basis functions to provide a first plurality of time-shifted basis functions; and
adding two or more of the first plurality of time-shifted basis functions to generate a plurality of groups of audio data.

16. The non-transitory computer-readable medium of claim 15, wherein the operation of applying the respective one of the plurality of weights includes:
applying a first one of the plurality of weights to a first one of the first plurality of basis functions; and
applying a second one of the plurality of weights to a second one of the first plurality of basis functions, wherein the first weight is different from the second weight.

17. The non-transitory computer-readable medium of claim 15, wherein the operation of applying the plurality of time shifts includes:
applying a first amount of time shift to a first one of the first plurality of weighted basis functions; and
applying a second amount of time shift to a second one of the first plurality of weighted basis functions, wherein the second amount is different from the first amount.

18. The non-transitory computer-readable medium of claim 15, wherein the operation of adding the two or more of the first plurality of time-shifted basis functions includes adding a first one of the first plurality of time-shifted basis functions with a second one of the first plurality of time-shifted basis functions to output a first one of the plurality of groups of audio data.

19. The non-transitory computer-readable medium of claim 15, wherein the first plurality of time-shifted basis functions include a first time-shifted basis function, a second time-shifted basis function, and a third time-shifted basis function, wherein the operation of adding the two or more of the plurality of time-shifted basis functions includes:
adding the first time-shifted basis function with the second time-shifted basis function; or
adding the first time-shifted basis function with the third time-shifted basis function; or
adding the second time-shifted basis function with the third time-shifted basis function; or
adding the first time-shifted basis function with the second and third time-shifted basis functions.

20. The non-transitory computer-readable medium of claim 15, wherein the operation of encoding the first audio dataset includes:
dividing movement of the first virtual object into a plurality of sets of movements of the first virtual object;
dividing a total time period of the movement of the first virtual object into the plurality of periods of time;
determining a first one of the first plurality of basis functions from a first of the plurality of sets of movements and a first one of the plurality of periods of time;
determining a second one of the first plurality of basis functions from a second one of the plurality of sets of movements and a second one of the plurality of periods of time.

21. The non-transitory computer-readable medium of claim 15, wherein the operations further include:
determining a similarity between the first virtual object and a second virtual object;
accessing a second audio dataset, wherein the second audio dataset is associated with the second virtual object;
encoding the second audio dataset to output a second plurality of basis functions, wherein each of the second plurality of basis functions is represented as respective one of a second plurality of sets of audio data output for a respective one of a second plurality of periods of time from the second virtual object;
applying a respective one of a second plurality of weights to a respective one of the second plurality of basis functions to output a second plurality of weighted basis functions;
applying a respective one of a second plurality of time shifts to a respective one of the second plurality of weighted basis functions to provide a second plurality of time-shifted basis functions; and
adding one or more of the second plurality of time-shifted basis functions with one or more of the first plurality of time-shifted basis functions to modify the plurality of groups of audio data.
